(19) United States
(12) Patent Application Publication
(10) Pub. No.: US 2014/0173294 A1
(43) Pub. Date: Jun. 19, 2014

(54) TECHNIQUES FOR EMULATING AN EEPROM DEVICE

(71) Applicant: BROADCOM CORPORATION, Irvine, CA (US)

(72) Inventor: Mark Buer, Payson, AZ (US)

(73) Assignee: BROADCOM CORPORATION, Irvine, CA (US)

(21) Appl. No.: 13/714,680

(22) Filed: Dec. 14, 2012

(51) Int. Cl. G06F 12/14

(52) U.S. Cl. CPC G06F 12/1408
USPC 713/193

(57) ABSTRACT

Disclosed are various embodiments of an emulation device for generating a cryptographic hash value associated with program data stored in a memory of a computing device. Validation data is generated based upon the cryptographic hash value and a flush counter of the computing device. The program data is encrypted in the computing device using an implementation of an encryption algorithm configured with at least a key stored in the memory. The program data is stored in a flash memory that is external to a processor of the computing device.

### BACKGROUND

Traditional computer processors may rely upon electrically erasable programmable read-only memory (EEPROM) to provide a source of non-volatile storage for data needed by the processor. However, EEPROM may suffer from numerous deficiencies, including the high cost of the EEPROM device and the slow performance of read and write operations.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an emulation environment according to various embodiments of the present disclosure.

FIG. 2 is a flowchart illustrating one example of functionality implemented as portions of a store application executed in an emulation device in the emulation environment of FIG. 1 according to various embodiments of the present disclosure.

FIG. 3 is a flowchart illustrating one example of functionality implemented as portions of a load application executed in an emulation device in the emulation environment of FIG. 1 according to various embodiments of the present disclosure.

FIG. 4 is a schematic block diagram that provides one example illustration of an emulation device employed in the emulation environment of FIG. 1 according to various embodiments of the present disclosure.

### DETAILED DESCRIPTION

Disclosed are various embodiments of an EEPROM emulation device that relies upon flash memory external to the processor package in order to provide non-volatile data storage. Using flash memory that is external to the processor package may simplify both development and testing costs associated with a processor. However, storing data external to the emulation device may increase the need to ensure the EEPROM data is stored confidentially and that the data integrity is validated prior to use. To that end, the EEPROM data stored in the flash memory may be encrypted prior to being written to the flash memory. Additionally, one or more cryptographic hashes may be generated based upon the EEPROM data and other data of the emulation device. These cryptographic hash(es) may be used to ensure the EEPROM data of the flash memory originated with the particular emulation device, and that the EEPROM data is the current version and not a “replay” or a copy of a prior version of the EEPROM data. In the following discussion, a general description of the system and its components is provided, followed by a discussion of the operation of the same.

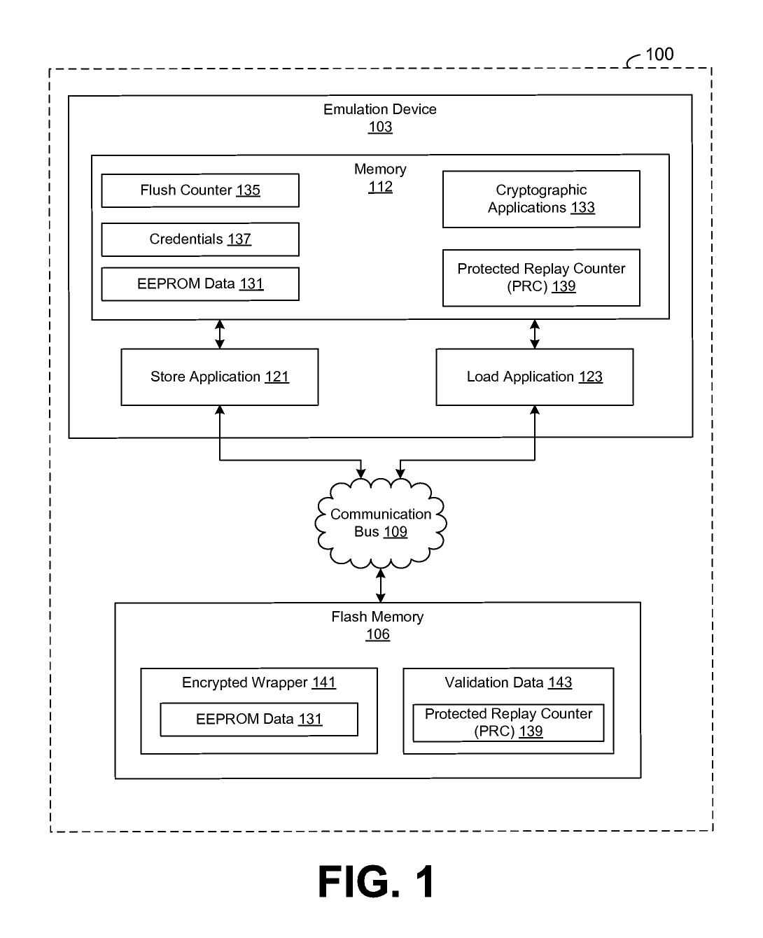

With reference to FIG. 1, shown is an emulation environment 100 according to various embodiments. The emulation environment 100 includes an emulation device 103 and a flash memory 106 in data communication with each other via a communication bus. The communication bus 109 includes, for example, a serial peripheral interface (SPI) bus, universal serial bus (USB), peripheral component interconnect express (PCIe) bus, etc., or any combination of two or more such communication buses.

The emulation device 103 may comprise, for example, a microcontroller, system on a chip (SoC), or any other system providing computing capability. Various applications and/or other functionality may be executed in the emulation device 103 according to various embodiments. Also, various data is stored in a memory 112 that is accessible to the emulation device 103, and the memory 112 may be located on the same chip or package as the emulation device 103. The memory 112 may be representative of a plurality of memories 112 as can be appreciated, including portions that may be capable of volatile storage and other portions capable of non-volatile storage. The data stored in the memory 112, for example, is associated with the operation of the various applications and/or functional entities described below.

The components executed on the emulation device 103, for example, include a store application 121, load application 123, and other applications, services, processes, systems, engines, or functionality not discussed in detail herein. The store application 121 is executed to synchronize the EEPROM data in the memory 112 to the flash memory 106. The store application 121 may further store various metadata associated with the EEPROM data to the flash memory 106 in order to validate the integrity and authenticity of the EEPROM data stored in the flash memory. The load application 123 is executed to restore EEPROM data from the flash memory 106 to the memory 112. The load application may retrieve various metadata associated with the EEPROM data in order to validate the integrity and authenticity of the EEPROM data stored in the flash memory.

The data stored in the memory 112 includes, for example, EEPROM data 131, cryptographic applications 133, flush counter 135, credentials 137, protected replay counter (PRC) 139, and potentially other data. The EEPROM data 131 may include various possible data of an EEPROM device to be emulated by the emulation device 103. The EEPROM data 131 may further include one or more cryptographic hashes of all or various portions of the EEPROM data 131 that may be used as a mechanism for integrity validation. The cryptographic applications 133 may include implementations of various cryptographic applications that may be used to encrypt, decrypt, validate, authenticate and/or various possible operations on the EEPROM data 131. As a non-limiting example, the cryptographic applications may include Advanced Encryption Standard (AES), Triple Data Encryption Standard (3-DES), Secure Hash Algorithm (SHA-1/2/3), Message Digest-5 (MD5), and/or other implementations of other possible algorithms.

The flush counter 135 may be a monotonically increasing counter value that may be used as a source of data from which a measure of authentication may be provided for EEPROM data 131 stored in the flash memory 106. The flush counter 135 may be stored in a non-volatile portion of the memory 112. The credentials 137 may include various possible secret keys, public keys, private keys, identifiers, and/or possible credentials as can be appreciated. The protected replay counter 139 may include one or more values providing integrity and authentication for the EEPROM data 131. To that end, the protected replay counter 139 may be based upon the EEPROM data 131, cryptographic hashes of the EEPROM data 131, the flush counter 135, one or more keys of the credentials 137, and/or other possible data.

The flash memory 106 is representative of one or more flash memory devices that may be coupled to the communication bus 109. The flash memory 106 may comprise, for example, NOR flash, NAND flash, serial flash, SPI flash, and/or other types of flash memory as can be appreciated. In some embodiments, the flash memory 106 may employ techniques such as, for example, “wear leveling” and bad block management (BBM), to improve the “endurance” of the flash memory 106 over numerous program-erase cycles. Various data is stored in the flash memory 106 that is accessible to the emulation device 103, and the flash memory 106 may be located external to the chip or package of the emulation device 103.

The data stored in the flash memory 106 includes, for example, an encrypted wrapper 141, validation data 143, and potentially other data. The encrypted wrapper 141 may be the encrypted form of the EEPROM data 131. The encrypted wrapper may be produced by one or more encryption algorithms available in the cryptographic applications 133. The validation data 143 includes various data that may be used to validate the integrity and authenticity of the EEPROM data 131. The validation data 143 may include one or more cryptographic hash values of the EEPROM data 131, one or more values of a protected replay counter 139 representing one or more versions of the EEPROM data 131, and/or other similar data as can be appreciated. The cryptographic hash values may be generated using MD5, SHA 1/2/3, and/or other cryptographic hash algorithms that may be available in the cryptographic applications 133.

Next, a general description of the operation of the various components of the emulation environment 100 is provided. To begin, EEPROM data 131 may be previously stored in flash memory 106 accessible to the emulation device 103. The EEPROM data 131 stored in the flash memory 106 may have further been encrypted using implementations of one or more encryption algorithms such as, for example, AES, 3-DES, Blowfish, and/or other possible encryption algorithms. The encryption algorithms may have been configured using a key, and potentially an initialization vector, based upon various possible credentials 137, as well as other possible data such as hardware address of a portion of the flash memory 106, counters for operations performed on the flash memory, results of cryptographic operations performed on these data items, and/or other possible sources of key entropy as can be appreciated.

The EEPROM data 131 and/or encrypted wrapper 141 of the flash memory 106 may have been used to produce various possible validation data 143. As described previously, the validation data 143 may include one or more cryptographic hash values that may be computed using implementations of one or more cryptographic hash algorithms that may also be available in the cryptographic applications 133. In some embodiments, the validation data 143 may further include a protected replay counter 139. The protected replay counter 139 may be a cryptographic hash value computed on the EEPROM data 131, encrypted wrapper 141, and/or on other cryptographic hash values computed on the aforementioned items.

Additionally, the protected replay counter 139 may have been computed using one or more keys of the credentials 137 and/or the flush counter 135, thereby creating an authenticating integrity check value such as a hash-based message authentication code (HMAC). By also including the flush counter 135 in the calculation of the protected replay counter 139, the protected replay counter 139 may be used to invalidate prior versions of the EEPROM data 131 stored using a prior value of the flush counter 135, as well as other potential integrity and authentication failures.

Once the emulation device 103 is powered-on, the load application 123 may evaluate the current value of the protected replay counter 139 stored in the memory 112. As discussed previously, portions of the memory 112 may be volatile memory requiring electrical power to maintain data in storage. The protected replay counter 139, the EEPROM data 131, and potentially other data may be stored in a volatile portion of the memory 112. In this circumstance, the protected replay counter 139, the EEPROM data 131, and other data stored in a volatile portion of the memory 112 may be erased and reset once electrical power is removed.

In some embodiments, upon electrical power being restored to the emulation device 103, the load application 123 may recognize the “reset value” of the protected replay counter as an indicator that the EEPROM data 131 should be reloaded from flash memory. In other embodiments, the load application 123 may validate the EEPROM data 131 using the stored value of the protected replay counter 139, albeit the “reset value.” For example, if the protected replay counter 139 has a value of “0000,” in some embodiments, the load application 123 may recognize this as a “reset value” indicating the EEPROM data 131 should be reloaded from flash memory 106 to the memory 112.

Prior to restoring the EEPROM data 131 from flash memory 106, the load application 123 may validate the authentication of the protected replay counter 139 stored in the validation data 143 of the flash memory 106. The operations associated with validating the authentication of the protected replay counter 139 may be used to ensure the protected replay counter 139 and associated EEPROM data 131 of the flash memory 106 originated with current emulation device 103 and are the versions last saved by the emulation device 103.

To that end, the load application 123 may generate a “current” protected replay counter for comparison with the protected replay counter 139 stored in the flash memory 106. The load application 123 may obtain the cryptographic hash values stored in the validation data 143. The load application 123 may further obtain the flush counter 135 and a key of the credentials 137 from a non-volatile portion of the memory 112. Using the cryptographic hash values, as well as potentially the flush counter 135 and a key of the credentials 137, the load application 123 may calculate a current protected replay counter value using as input the cryptographic hash values stored in the validation data 143, as well as the flush counter 135 and/or a key of the credentials 137.

The cryptographic hash function used should be the same cryptographic hash function used previously to calculate the protected replay counter 139 stored in the flash memory 106 and may include SHA-1, SHA-2, SHA-3, MD5, and/or other possible cryptographic hash functions as can be appreciated. Thereafter, the load application 123 may validate the protected replay counter 139 stored in the flash memory 106 by comparing the stored protected replay counter 139 with the current protected replay counter. If the stored protected replay counter 139 is successfully validated, protected replay counter 139 of the flash memory 106 is authenticated, thereby passing a threshold toward authenticating and validating the integrity of the EEPROM data 131 stored in the flash memory 106.

For example, if the protected replay counter 139 is based in part upon the flush counter 135, the flush counter 135 may increment each time a new version of the EEPROM data 131 is written to the flash memory 106. Therefore, any attempts to replace the contents of the flash memory 106 with a prior version of the contents of the flash memory 106, may be detectable because the prior version of the protected replay counter 139 would have been calculated using a prior version of the flush counter 135. Once the load application attempts to validate the prior version of the protected replay counter 139 as described previously, the current value of the flush counter 135 would be used, thereby creating a different protected replay counter value than the prior version of the protected replay counter 139 stored in the flash memory 106.

Similarly, for example, if the protected replay counter 139 is based in part upon a key of the credentials 137, the key may be unique to the particular emulation device 103. Therefore, any attempts to replace the contents of the flash memory 106 with a version of the contents of the flash memory 106 from another device, may be detectable because the stored version of the protected replay counter 139 would have been calculated using a different key or no key at all. Once the load application attempts to validate the stored version of the protected replay counter 139 as described previously, the unique key of the particular emulation device 103 would be used, thereby creating a different protected replay counter value than the stored version of the protected replay counter 139 of the flash memory 106.

In some embodiments, one or more prior versions of EEPROM data 131 and corresponding protected replay counter 139 may also be stored in the flash memory 106. In these embodiments, if the most recent protected replay counter 139 cannot be validated, the prior versions may instead be validated using known prior values of the flush counter 135. If a prior version of the protected replay counter 139 can be validated, the EEPROM data 131 corresponding to this version of protected replay counter 139 may be selected.

Once the protected replay counter 139 of the flash memory has been validated, the EEPROM data 131 may be decrypted from the encrypted wrapper 141. The EEPROM data 131 may decrypted using a cryptographic application 133 implementing same the cryptographic algorithm used to encrypt the EEPROM data 131 in the encrypted wrapper 141. The cryptographic algorithms may include AES, 3-DES, and/or other cryptographic algorithms as can be appreciated. In some embodiments, the EEPROM data 131 extracted from the encrypted wrapper 141 may be stored in the memory 112, though it may not be operational until validation completes.

After extracting the EEPROM data 131, a cryptographic hash value may be calculated for the EEPROM data 131. This cryptographic hash value may be used to validate that the EEPROM data 131 extracted from the encrypted wrapper 141 does indeed correspond to the data upon which the previously validated protected replay counter 139 was based. This operation may be carried out by comparing the current cryptographic hash value calculated for the extracted EEPROM data 131 with the cryptographic hash value stored in the validation data 143 which was used to previously validate the protected replay counter 139. If the cryptographic hash values match, the EEPROM data 131 extracted from the encrypted wrapper 141 has been successfully validated and may be made operationally available in the memory 112.

During the course of operation of the emulation device 103, updates may be made to the EEPROM data 131 that is stored in the memory 112. The store application 121 may calculate one or more cryptographic hash values in response to updates made to the EEPROM data 131. The current cryptographic value(s) may be stored as part of the EEPROM data 131 or elsewhere in the memory 112. Furthermore, the store application 121 may calculate a new protected replay counter 139 based upon updates to the EEPROM data 131 and the associate cryptographic hash values. As described previously, the protected replay counter 139 may be a cryptographic hash value calculated from the one or more cryptographic hash values for the EEPROM data 131 of the memory 112, as well as potentially the flush counter 135 and/or a key from the credentials 137.

The store application 121 may encrypt the updated EEPROM data 131 of the memory 112 in an encrypted wrapper 141 to be stored in the flash memory 106. Storing the EEPROM data 131 may preserve the state of the EEPROM data 131 in the event of an electrical power interruption to the emulation device 103, while encrypting the EEPROM data 131 preserves confidentiality of the data stored in the flash memory 106. In some embodiments, only updated portions of the EEPROM data 131 may be encrypted and stored in the flash memory 106, thereby leaving intact the last version of EEPROM data 131 loaded from the flash memory 106, while also storing subsequent changes.

However, in embodiments in which the protected replay counter 139 is computed using the flush counter 135, the protected replay counter 139 may not be stored in the validation data 143 of the flash memory 106 until the flush counter 135 is incremented. The flush counter 135 may be incremented in the event that electrical power to the emulation device 103 is interrupted and/or other possible reasons. In the event the power is interrupted, the emulation device 103 may use a power fail block to ensure sufficient power exists to compute an updated the protected replay counter 139 using the new value of the flush counter 135 and write the updated protected replay counter 139 to the flash memory 106. During operation of the emulation device 103 in which electrical power is still available, the EEPROM data 131 and protected replay counter 139 may be preserved for operational use within memory 112.

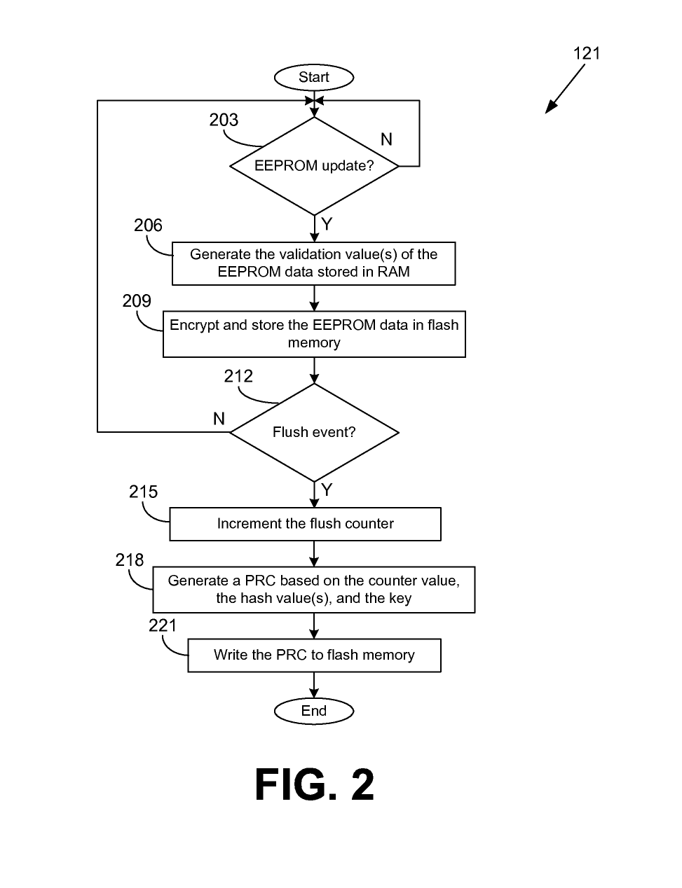

Referring next to FIG. 2, shown is a flowchart that provides one example of the operation of a portion of the store application 121 according to various embodiments. It is understood that the flowchart of FIG. 2 provides merely an example of the many different types of functional arrangements that may be employed to implement the operation of the portion of the store application 121 as described herein. As an alternative, the flowchart of FIG. 2 may be viewed as depicting an example of steps of a method implemented in the emulation device 103 (FIG. 1) according to one or more embodiments.

This portion of the execution of the store application 121 may be executed during the course of operation of the emulation device 103 while EEPROM data 131 (FIG. 1) is presently stored in the memory 112 (FIG. 1). The store application 121 may be used to ensure that a copy of operational EEPROM data 131 stored in the memory 112 is synchronized to the non-volatile flash memory 106 (FIG. 1). Beginning with block 203, the store application 121 may determine if the EEPROM data 131 of the memory 112 has been updated. If no updates have been performed, the store application 121 may continue to monitor the EEPROM data 131 for future updates.

Alternatively, if updates have been made, the store application 121 may, in block 206, calculate one or more validation values in response to updates made to the EEPROM data 131. The validation values may include one or more cryptographic hash values of the EEPROM data 131, as well as potentially a new protected replay counter (PRC) 139 (FIG. 1) based upon the cryptographic hash values. As described previously, the protected replay counter 139 may be a cryptographic hash value calculated from the one or more cryptographic hash values for the EEPROM data 131 of the memory 112, the flush counter 135 (FIG. 1), and a key from the credentials 137 (FIG. 1).

Next, in block 209, the store application 121 may encrypt the updated EEPROM data 131 of the memory 112 in an encrypted wrapper 141 (FIG. 1) to be stored in the flash memory 106. Storing the EEPROM data 131 may preserve the state of the EEPROM data 131 in the event of an electrical power interruption to the emulation device 103, while encrypting the EEPROM data 131 preserves confidentiality of the data stored in the flash memory 106. In some embodiments, only updated portions of the EEPROM data 131 may be encrypted and stored in the flash memory 106, thereby leaving intact one or more previous versions of the EEPROM data 131 loaded from the flash memory 106, while also storing subsequent changes.

Continuing, in block 212, the store application may determine if an event has occurred requiring the protected replay counter 139 to be flushed to the flash memory 106, such as an interruption to electrical power. If a flush event has not occurred, execution of the store application 121 may return to block 203. Alternatively, if a flush event has occurred, in block 215, the store application may increment the flush counter 135 (FIG. 1), in effect making a version marker for the EEPROM data 131 of the flash memory 106.

Then, in block 218, the store application 121 may calculate a new protected replay counter 139 from the one or more cryptographic hash values for the EEPROM data 131 of the flash memory 106, the flush counter 135, and a key from the credentials 137. Next, in block 221, the protected replay counter 139 may be written to the validation data 143 (FIG. 1) of the flash memory 106. In some embodiments, one or more prior versions of the protected replay counter 139 may be preserved in the flash memory 106. The emulation device 103 may use a power fail block to ensure sufficient power exists, in the event of a power failure, to compute an updated protected replay counter 139 using the new value of the flush counter 135 and write the updated protected replay counter 139 to the flash memory 106. Thereafter, this portion of the operation of the store application 121 may end as shown.

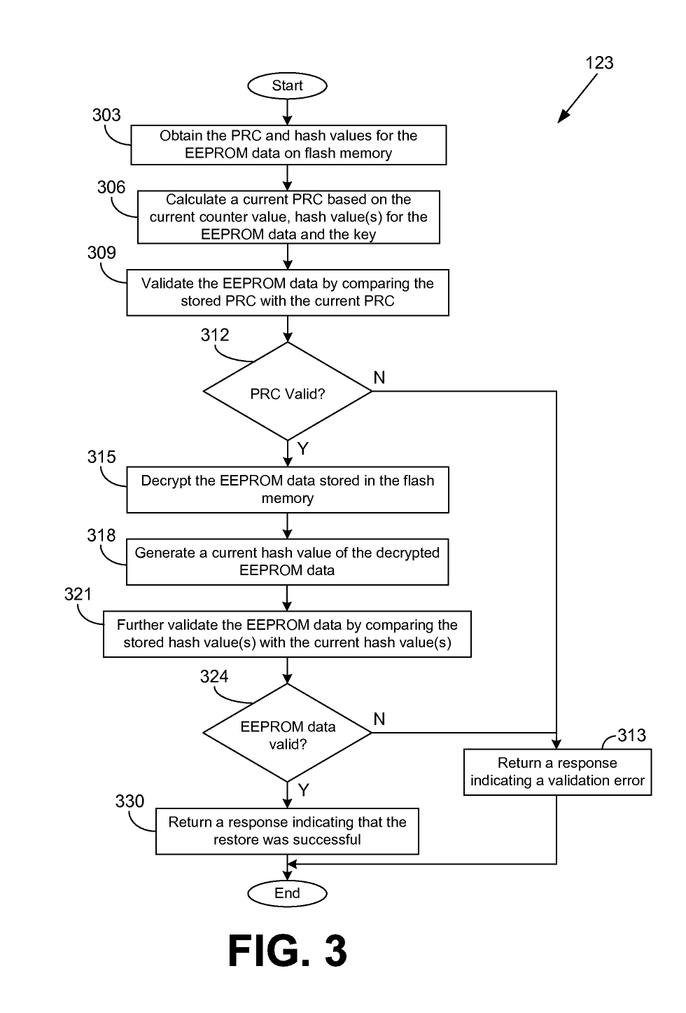

Turning now to FIG. 3, shown is a flowchart that provides one example of the operation of a portion of the load application 123 according to various embodiments. It is understood that the flowchart of FIG. 3 provides merely an example of the many different types of functional arrangements that may be employed to implement the operation of the portion of the load application 123 as described herein. As an alternative, the flowchart of FIG. 3 may be viewed as depicting an example of steps of a method implemented in the emulation device 103 (FIG. 1) according to one or more embodiments.

This portion of the execution of the load application 123 may be executed in response to a request to restore the EEPROM data 131 (FIG. 1) from the flash memory 106 (FIG. 1) to the memory 112 (FIG. 1). Such a restoration operation may occur due to an interruption of electrical power to the emulation device 103 or other possible reasons. Beginning with block 303, the load application 123 may validate the authentication of the protected replay counter 139 (FIG. 1) stored in the validation data 143 (FIG. 1) of the flash memory 106 by first obtaining the protected replay counter 139 and hash value(s) associated with the EEPROM data 131. The operations associated with validating the authentication of the protected replay counter 139 may be used to ensure the protected replay counter 139 and associated EEPROM data 131 of the flash memory 106 originated with current emulation device 103 and are the versions last saved by the emulation device 103.

Next, in block 306, the load application 123 may generate a current protected replay counter for comparison with the protected replay counter 139 stored in the flash memory 106. To that end, the load application 123 may further obtain the flush counter 135 (FIG. 1) and a key of the credentials 137 (FIG. 1) from a non-volatile portion of the memory 112. Thereafter, the load application 123 may calculate a current protected replay counter value using as input the cryptographic hash values stored in the validation data 143, as well as the flush counter 135 and/or a key of the credentials 137.

Then, in block 309, the load application 123 may validate the protected replay counter 139 stored in the flash memory 106 by comparing the stored protected replay counter 139 with the current protected replay counter. Continuing, in block 312, the load application 123 may determine if the stored protected replay counter 139 is successfully validated.

If the protected replay counter 139 did not match the current protected replay counter, then, in block 313, the load application 123 may return a response indicating the validation failed. In some embodiments, one or more prior versions of EEPROM data 131 and corresponding protected replay counter 139 may also be stored in the flash memory 106. In these embodiments, if the most recent versions of the EEPROM data 131 and corresponding protected replay counter 139 cannot be validated, a prior version of the protected replay counter 139 may instead be validated using known prior values of the flush counter 135. If a prior version of the protected replay counter 139 can be validated, the EEPROM data 131 corresponding to this version of protected replay counter 139 may then be selected for validation.

Alternatively, if the validation is successful, in block 315, the load application 123 may decrypt the EEPROM data 131 from the encrypted wrapper 141 (FIG. 1). The EEPROM data 131 may decrypted using a cryptographic application 133 (FIG. 1) implementing same the cryptographic algorithm used to encrypt the EEPROM data 131 in the encrypted wrapper 141.

Moving on, in block 318, the load application 123 may calculate one or more cryptographic hash values for the EEPROM data 131. Next, in block 321, the load application 123 may use the cryptographic hash values to validate that the EEPROM data 131 extracted from the encrypted wrapper 141 does indeed correspond to the data upon which the previously validated protected replay counter 139 was based. This operation may be carried out by comparing the current cryptographic hash value calculated for the extracted EEPROM data 131 with the cryptographic hash value stored in the validation data 143 which was used to previously validate the protected replay counter 139.

Then, in block 324, the load application 123 may determine if the EEPROM data 131 was valid. If the cryptographic hash value(s) calculated for the extracted EEPROM data 131 do not match the cryptographic hash value(s) stored in the validation data 143 used to previously validate the protected replay counter 139, then execution of the load application 123 may return to block 313. Alternatively, if the validation is successful, in block 330, the load application 123 may return a response indicating that the EEPROM data was validated and successfully restored to the memory 112.

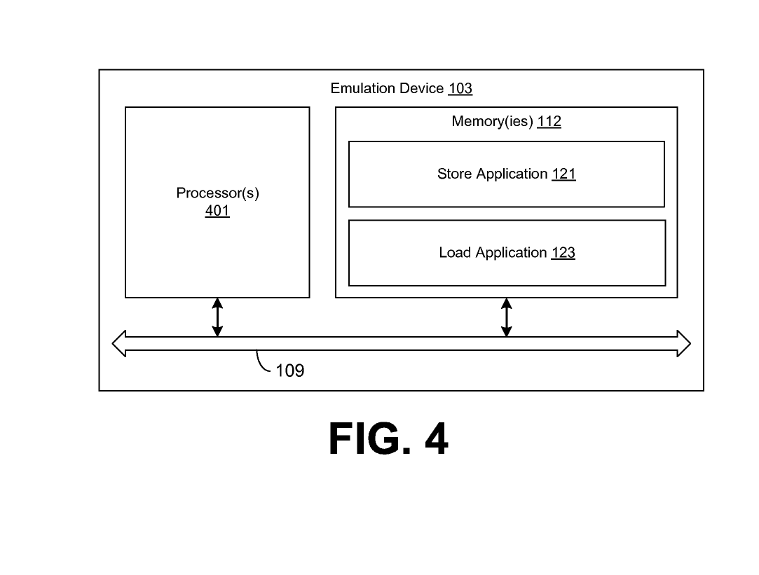

With reference to FIG. 4, shown is a schematic block diagram of the emulation device 103 according to an embodiment of the present disclosure. Each emulation device 103 includes at least one processor circuit, for example, having a processor 401 and a memory 112, both of which are coupled to a communication bus 109. The communication bus 109 may comprise, for example, a data bus with an accompanying address/control bus or other bus structure as can be appreciated.

Stored in the memory 112 are both data and several components that are executable by the processor 401. In particular, stored in the memory 112 and executable by the processor 401 are a store application 121, load application 123, and potentially other applications. In addition, an operating system may be stored in the memory 112 and executable by the processor 401.

It is understood that there may be other applications that are stored in the memory 112 and are executable by the processor 401 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 112 and are executable by the processor 401. In this respect, the term “executable” means a program file that is in a form that can ultimately be run by the processor 401. Examples of executable programs may be, for example, a compiled program that can be translated into machine code in a format that can be loaded into a random access portion of the memory 112 and run by the processor 401, source code that may be expressed in proper format such as object code that is capable of being loaded into a random access portion of the memory 112 and executed by the processor 401, or source code that may be interpreted by another executable program to generate instructions in a random access portion of the memory 112 to be executed by the processor 401, etc. An executable program may be stored in any portion or component of the memory 112 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 112 is defined herein as including both volatile and nonvolatile memory and data storage components. Volatile components are those that do not retain data values upon loss of power. Nonvolatile components are those that retain data upon a loss of power. Thus, the memory 112 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 401 may represent multiple processors 401 and/or multiple processor cores and the memory 112 may represent multiple memories 112 that operate in parallel processing circuits, respectively. In such a case, the communication bus 109 may be an appropriate communication bus that facilitates communication between any two of the multiple processors 401, between any processor 401 and any of the memories 112, or between any two of the memories 112, etc. The communication bus 109 may comprise additional systems designed to coordinate this communication, including, for example, performing load balancing. The processor 401 may be of electrical or of some other available construction.

Although the store application 121, load application 123, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 2 and 3 show the functionality and operation of an implementation of portions of the store application 121 and load application 123, respectively. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 401 in a computer system or other system. The machine code may be converted from the source code, etc. If embodied in hardware, each block may represent a circuit or a number of interconnected circuits to implement the specified logical function(s).

Although the flowcharts of FIGS. 2 and 3 show a specific order of execution, it is understood that the order of execution may differ from that which is depicted. For example, the order of execution of two or more blocks may be scrambled relative to the order shown. Also, two or more blocks shown in succession in FIGS. 2 and 3 may be executed concurrently or with partial concurrence. Further, in some embodiments, one or more of the blocks shown in FIGS. 2 and 3 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the store application 121 and load application 123, that comprises software or code can be embodied in any non-transitory computer-readable medium for use by or in connection with an instruction execution system such as, for example, a processor 401 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A system, comprising:
a computing device comprising a processor and a memory, the memory comprising a flush counter and a field for current validation data, the field having a value indicating a state of current EEPROM data in the memory; and
an application executable in the computing device, the application configured to:
determine whether to refresh the current EEPROM data in the memory in response to the value associated with the field;
obtain stored validation data associated with stored EEPROM data encrypted in a flash memory, the flash memory being external to a chip of the processor, and the stored validation data comprising a pre-defined cryptographic hash value generated based at least upon the stored EEPROM data, the flush counter, and a key stored in the memory;
decrypt the stored EEPROM data using the key, the stored EEPROM data being placed into the memory;
generate the current validation data based at least upon the stored EEPROM data placed in the memory, the flush counter, and the key; and
generate a validation indicator for the stored EEPROM data, the validation indicator being produced in response to a comparison of the current validation data and the stored validation data.

2. The system of claim 1, wherein the memory is located on the chip of the processor.

3. The system of claim 1, wherein a portion of the memory is non-volatile, the flush counter and the key being stored in the non-volatile portion of the memory.

4. A method, comprising the steps of:
generating, in a computing device, a first cryptographic hash value associated with program data stored in a memory of the computing device, the first cryptographic hash value being generated in response to an update to the program data in the memory;
generating, in the computing device, validation data based at least upon the first cryptographic hash value and a flush counter of the computing device, the validation data being a second cryptographic hash value stored in the memory;
encrypting, in the computing device, the program data using an implementation of an encryption algorithm configured with at least a key stored in the memory; and
storing the encrypted program data in a flash memory of the computing device, the flash memory being external to a processor of the computing device.

5. The method of claim 4, wherein the encryption algorithm is further configured with a random value stored in the processor.

6. The method of claim 5, wherein the encryption algorithm is a symmetric stream cipher algorithm.

7. The method of claim 4, wherein a portion of the program data is executable by the processor.

8. The method of claim 4, wherein the validation data is further based upon the key.

9. The method of claim 4, further comprising the steps of:
incrementing, in the computing device, the flush counter in response to a request to synchronize data to the flash memory; and
generating, in the computing device, modified validation data based at least upon the first cryptographic hash value and the incremented flush counter of the computing device, the modified validation data being stored in the flash memory.

10. The method of claim 9, wherein a power-fail buffer is used to store the modified validation data in the flash memory, the power-fail buffer ensuring the modified validation data is stored without requiring an external power source.

11. The method of claim 9, wherein the flash memory further comprises a previous version of the program data, the previous version corresponding to a state of the program data prior to the update.

12. A system, comprising:
a computing device comprising a processor and a memory, the memory comprising a flush counter; and
an application executable in the computing device, the application configured to:
obtain stored validation data associated with program data stored in a flash memory, the flash memory being external to a chip of the processor, and the stored validation data comprising a pre-defined cryptographic hash value generated based at least upon the program data and the flush counter;
generate current validation data based at least upon the program data and the flush counter; and
generate a validation indicator for the program data, the validation indicator being produced in response to a comparison of the current validation data and the stored validation data.

13. The system of claim 12, wherein the memory is located on the chip of the processor.

14. The system of claim 12, wherein the memory further comprises a field for a restore indicator, and the application is further configured to determine whether the program data should be obtained from the flash memory based at least upon the restore indicator.

15. The system of claim 12, wherein the flush counter increments monotonically.

16. The system of claim 12, wherein the flush counter increments in response to a power loss state of the computing device.

17. The system of claim 12, wherein the program data stored in the flash memory is encrypted.

18. The system of claim 17, wherein the application is further configured to decrypt the program data, the current validation data being based upon a decrypted form of the program data.

19. The system of claim 12, wherein the application is further configured to store the program data in the memory.

20. The system of claim 19, wherein the application is further configured to generate a backup validation using a previous version of the stored validation data, the previous version of the stored validation data being associated with a previous version of the program data stored in the flash memory.
